(19) United States
(12) Patent Application Publication
(10) Pub. No.: US 2020/0132879 A1
(43) Pub. Date: Apr. 30, 2020

(54) Equipment using X-ray for security detection

(71) Applicant: Jiabin Dong, Yuyao City (CN)

(72) Inventor: Jiabin Dong, Yuyao City (CN)

(21) Appl. No.: 16/729,490

(22) Filed: Dec. 30, 2019

(30) Foreign Application Priority Data
Oct. 29, 2019 (CN) 2019110392492

(51) Int. Cl. G01V 5/00; G01N 23/046

(52) U.S. Cl. CPC G01V 5/0016; G01N 23/046

(57) ABSTRACT

The invention relates to the field of security inspection equipment, in particular to a device for performing security detection using X-rays, comprising a fuselage and detection chambers provided in the fuselage and connected to the left and right sides of the fuselage, and the detection chamber can be rotated. A rotating frame is provided, and a power receiving ring is provided at a middle position of the rotating frame. A sliding groove is provided in four brackets provided on the rotating frame, and an electric pole is slidably provided in the sliding groove. A first spring is provided between the power receiving pole and the wall of the sliding groove, and the power connecting wire is electrically connected between the power receiving pole and the power receiving ring. The invention provides a device for detecting security by using X-rays.

### CROSS-REFERENCES TO RELATED APPLICATIONS

The present application claims priority from Chinese application No. 2019110392492 filed on Oct. 29, 2019 which is hereby incorporated by reference in its entirety.

### FIELD OF TECHNOLOGY

The invention relates to the technical field of security inspection equipments, and in particular relates to an equipment using X-ray for security detection.

### TECHNICAL FIELD

When the traditional security equipment is used to transfer items, the lighter weight items are easily blocked by the covering curtain and the items cannot be accessed. The traditional security equipment needs to lift the heavy items up and down during the security check of the heavy quality items. The detection cavity of the traditional security inspection equipment is only blocked by a curtain, and there is a risk of X-ray leakage. Therefore, it is necessary to set up a device that uses X-rays for security inspection to improve the above problems.

### CONTENT OF THE INVENTION

The purpose of the present invention is to provide a device for performing security detection using X-rays, which can overcome the above-mentioned defects of the prior art, thereby improving the practicability of the device.

The technical solution adopted by the present invention to solve its technical problems is: An apparatus for security detection using X-rays of the present invention includes a fuselage and detection chambers provided in the fuselage and connected to the left and right sides of the fuselage, A rotating frame is rotatably provided in the detection cavity, a power receiving ring is provided at a middle position of the rotating frame, four brackets provided on the rotating frame are provided with sliding grooves, and the sliding grooves are slidably arranged. There is an electric pole, a first spring is provided between the electric pole and the sliding groove wall body, and an electric wire is electrically connected between the electric pole and the electric ring, and the front end of the lower left corner An X-ray generator (not shown) is provided in the wall, and an X-ray imager that generates X-rays due to receiving the X-ray generator (not shown) is provided in the rear end wall of the lower left corner of the detection cavity. The detection The left end wall and the bottom wall of the cavity are provided with contacts that cooperate with the power pole, and a controller that controls the activation of the X-ray generator (not shown) is provided between the two contacts. The controller controls the X-rays when two of the contacts are in contact with the pole at the same time A generator (not shown) irradiates the lower left corner of the detection cavity once. At this time, the X-ray imager receives an X-ray and forms an image for the security personnel to inspect. The inspected items rotate downward with the turret. Move so as to move out of the exit provided in the right end wall of the detection chamber above the conveyor provided in the fuselage, and the conveyor provided in the transmission rotates to move the inspected equipment out of the equipment;

A rotatable seal door is provided at the left entrance of the detection cavity, and the seal door can be opened only when both of the contacts are in contact with the power pole. The turret is not rotating;

A lifting device for lifting heavy objects is provided on the left side of the fuselage, and the lifting device drives the support plate provided on the left side of the fuselage to move up and down to move the weight from a lower position to the detection cavity. The entrance set on the left.

Further, the transmission device includes a transmission cavity provided in the fuselage, and a left-right symmetrical first rotation shaft is rotatably disposed in the transmission cavity. The rear end of the first rotation shaft on the left side of the transmission wheel is connected to a transmission cavity in the engagement cavity provided in the rear end wall of the detection cavity, and the first rotation shaft end in the engagement cavity is fixedly disposed. There is a first gear, and a second rotating shaft fixedly connected to the rotating frame is rotatably provided between the rotating frame and the meshing cavity, and the end of the second rotating shaft in the meshing cavity is fixedly provided with the first rotating shaft. A second gear meshed by a gear, a front end of the first rotation shaft on the left side extends into a transmission cavity provided in a front end wall of the transmission cavity, and a third gear is fixedly disposed at the end.

Further, the sealed door is hingedly connected to the top wall of the detection chamber, a torsion spring is provided between the sealed door and the hinge shaft to drive the sealed door to automatically reset, and is arranged in the right end wall of the fuselage. A groove is provided in the bottom wall of the groove, and a sliding hole with an upward opening is provided in the bottom wall of the groove, and the top end is slidably provided in a locking groove provided in the bottom wall of the sealed door. An electromagnet matching the lock lever is provided in the bottom wall, a second spring is provided between the lock lever and the electromagnet, and an induction sensing the sealed door is provided in the right end wall of the groove. Device.

Further, the lifting device includes a third rotating shaft that is rotatably disposed on the left side of the fuselage, and an outer surface of the third rotating shaft is fixedly provided with a swing lever, and the end of the swing lever that is far away from the third rotation shaft is hingedly connected with On the bottom wall of the support plate, a front-rear symmetrical hinge rod is hingedly connected to the bottom wall of the support plate, and the end of one side of the hinge rod away from the support plate is rotationally connected to the end wall of the fuselage. A rotation cavity is provided in the bottom wall of the cavity, and a worm gear that is fixedly engaged with the worm wheel on the outer surface of the third rotating shaft is provided in the left end wall of the rotation cavity. The end of the worm in the rotation cavity is fixedly provided with A first bevel gear, a fourth rotating shaft is rotatably provided between the rotating cavity and the transmission cavity, and a second bevel meshing with the first bevel gear is fixedly provided at the end of the fourth rotating shaft in the rotating cavity. A gear, a fourth gear is fixedly disposed at the end of the fourth rotating shaft in the transmission cavity.

Further, a sliding cavity opening forward is provided in the rear end wall of the transmission cavity, and a sliding block is slidably disposed in the sliding cavity. A driving motor is fixed in the front end wall of the sliding block. A fifth gear that meshes with the third gear is fixedly arranged at the end of the output shaft of the driving motor, and an electric push rod electrically connected to the inductor is arranged in the top wall of the sliding cavity.

Beneficial effects of the present invention: A device for performing security detection using X-rays provided by the present invention can facilitate the use of X-rays to carry out security checks on carried items. The device solves the problem that traditional security devices cannot be sent to the device for detection when transmitting lighter items Problems in the cavity, at the same time, the device can assist in lifting heavy-weight items, which is very convenient to use. This device completely seals the X-ray irradiation area to avoid radiation leakage.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those skilled in the art, other drawings can be obtained based on these drawings without paying creative labor.

The invention is further described below with reference to the drawings and embodiments.

FIG. 1 is a schematic diagram of the overall structure of a device for detecting security by using X-rays in the present invention.

FIG. 2 is a schematic structural diagram of A-A in FIG. 1.

FIG. 3 is a schematic enlarged view of B in FIG. 1.

FIG. 4 is an enlarged structural diagram of C in FIG. 2.

### DETAILED DESCRIPTION OF THE INVENTION

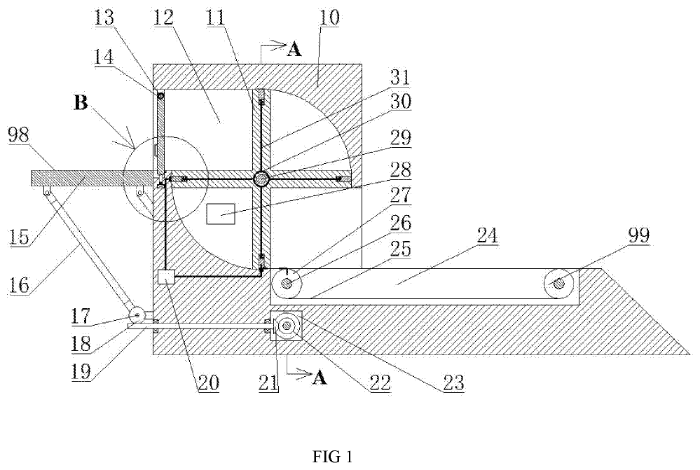

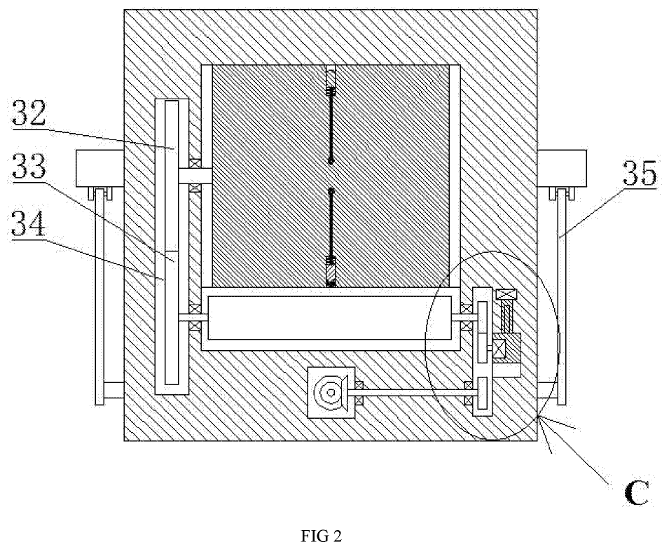

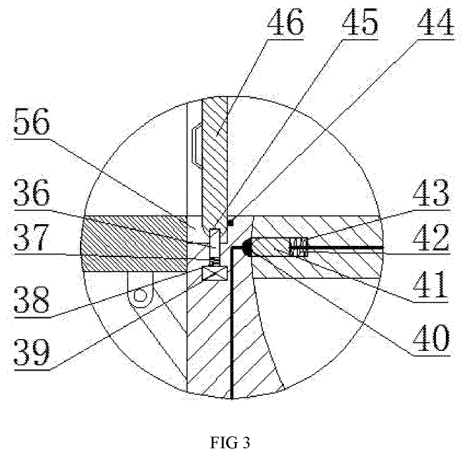

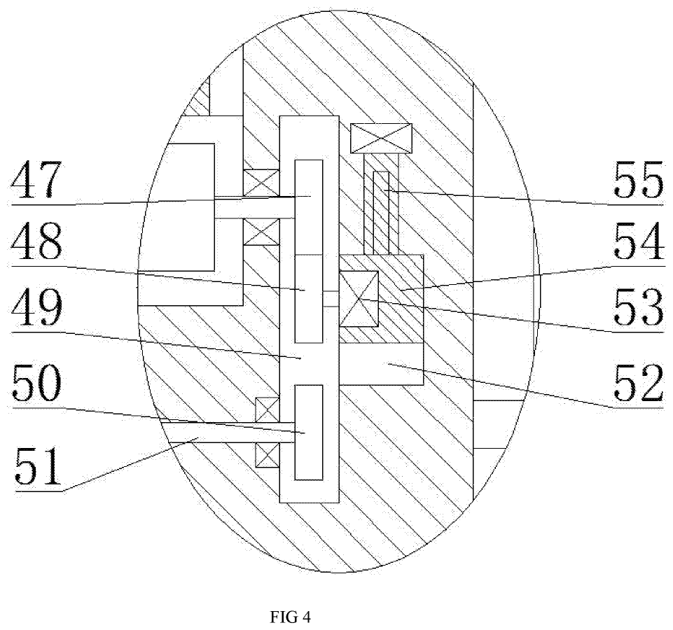

The present invention is described in detail below with reference to FIGS. 1-4. For convenience of description, the orientation described below is defined as follows: the up-down, left-right, front-back direction described below is consistent with the up-down left-right, front-back direction of the projection relationship of FIG.

A device for performing security detection using X-rays as described in conjunction with FIGS. 1-4 includes a fuselage 10 and detection chambers 12 provided in the fuselage 10 and connected to the left and right sides of the fuselage 10, and the detection A rotating frame 11 is rotatably provided in the cavity 12, and a power receiving ring 30 is provided at a middle position of the rotating frame 11. A sliding groove 43 is provided in four brackets provided on the rotating frame 11. A power receiving pole 41 is slidably provided, and a first spring 42 is provided between the power receiving pole 41 and a wall of the sliding groove 43. A power connecting wire is provided between the power receiving pole 41 and the power receiving ring 30. 31 Electricity Union, an X-ray generator (not shown) is provided in the front end wall of the lower left corner, and an X-ray generator (not shown) is provided in the rear end wall of the detection chamber 12 in the lower left corner An X-ray imager 28 that generates X-rays, a contact 40 that cooperates with the power pole 41 is provided in the left end wall and the bottom wall of the detection cavity 12, and a control is provided between the two contacts 40 The controller 20 activated by the X-ray generator (not shown), when two of the contacts 40 are in contact with the power pole 41 at the same time, the controller 20 controls The X-ray generator (not shown) irradiates the lower left corner of the detection chamber 12 once. At this time, the X-ray imager 28 forms an image for the security personnel to view after receiving the X-ray. The inspected items accompany the inspection. The turret 11 moves downward to move from the exit provided in the right end wall of the detection chamber 12 to above the conveying device 99 provided in the main body 10, and the conveying belt 25 provided in the transmission device 99 rotates to move The inspected equipment is moved out of the equipment;

A sealing door 46 is rotatably provided at the left entrance of the detection chamber 12, and the sealing door 46 can be opened only when both of the contacts 40 are in contact with the power pole 41. After the sealed door 46 is opened, the rotating frame 11 is not rotating;

A lifting device 98 for lifting heavy objects is provided on the left side of the fuselage 10, and the lifting device 98 drives the support plate 15 provided on the left side of the fuselage 10 to move up and down, thereby moving the weight from a lower position To the entrance provided on the left side of the detection cavity 12.

Advantageously, the transmission device 99 includes a transmission cavity 24 provided in the fuselage 10, and a left-right symmetrical first rotation shaft 26 is rotatably disposed in the transmission cavity 24. The surface is fixedly provided with a transmission wheel 27 driven by the transmission belt 25. The rear end of the first rotating shaft 26 on the left side extends into an engagement cavity 34 provided in the rear end wall of the detection cavity 12. A first gear 33 is fixed at the end of the first rotating shaft 26 in the cavity 34, and a second rotating shaft 29 fixedly connected to the rotating frame 11 is rotatably provided between the rotating frame 11 and the meshing cavity 34. A second gear 32 meshing with the first gear 33 is fixedly disposed at the end of the second rotating shaft 29 in the engaging cavity 34, and the front end of the first rotating shaft 26 on the left side extends into the front of the transmitting cavity 24. A third gear 47 is fixedly disposed in the transmission cavity 49 provided in the side end wall and at the end.

Beneficially, the sealed door 46 is hingedly connected to the top wall of the detection cavity 12, and a torsion spring 14 is provided between the sealed door 46 and the hinge shaft 13 to drive the sealed door 46 to automatically reset. 10 A groove 56 is provided in the right end wall, and a sliding hole 37 with an upward opening is provided in the bottom wall of the groove 56, and a top end is slidably provided in the sliding hole 37 and extends into the bottom of the sealing door 46. In the locking groove 45 provided in the wall, an electromagnet 39 matching with the lock lever 36 is provided in the bottom wall of the sliding hole 37, and a second spring 38 is provided between the lock lever 36 and the electromagnet 39. An inductor 44 is disposed in the right end wall of the groove 56 to sense the sealed door 46.

Beneficially, the lifting device 98 includes a third rotating shaft 17 that is rotatably provided on the left side of the fuselage 10, and an outer surface of the third rotating shaft 17 is fixedly provided with a swing lever 16 that is far from the third rotation shaft. 17 The end of one side is hingedly connected to the bottom wall of the support plate 15. The front and rear symmetrical hinge rods 35 are hingedly connected to the bottom wall of the support plate 15. The hinged rod 35 is rotatably connected away from the end of the support plate 15. On the end wall of the fuselage 10, a rotation cavity 23 is disposed in the bottom wall of the transmission cavity 24, and a worm wheel fixedly disposed on the outer surface of the third rotation shaft 17 is disposed in the left end wall of the rotation cavity 23 18 meshing worm 19, the first end of the worm 19 in the rotating cavity 23 is fixedly provided with a first bevel gear 21, a fourth rotating shaft 51 is rotatably provided between the rotating cavity 23 and the transmission cavity 49, A second bevel gear 22 meshing with the first bevel gear 21 is fixedly provided at the end of the fourth rotating shaft 51 in the rotation cavity 23, and a fourth bevel gear 22 is fixedly provided at the end of the fourth rotating shaft 51 in the transmission cavity 49. Gear 50.

Beneficially, a sliding cavity 52 opening forward is provided in the rear end wall of the transmission cavity 49, and a sliding block 54 is slidably disposed in the sliding cavity 52.

The front end wall of the sliding block 54 is fixedly disposed in the sliding cavity 52. A driving motor 53 is provided, and a fifth gear 48 meshing with the third gear 47 is fixedly arranged at the end of the output shaft of the driving motor 53. An electric motor electrically connected to the inductor 44 is provided in the top wall of the sliding cavity 52. Putter 55.

The fixed connection method described in this embodiment includes, but is not limited to, methods such as bolt fixing and welding.

The sequence of mechanical actions of the entire device:

1. When the device of the present invention is operating, the driving motor 53 is started to drive the fifth gear 48 to rotate, thereby driving the third gear 47 to rotate, thereby driving the first rotating shaft 26 to rotate, thereby driving the first A gear 33 rotates, thereby driving the second gear 32 to rotate, thereby driving the turret 11 to rotate. When an item security inspection is required, the sealing door 46 is pulled to the left, and when both of the contacts 40 are in contact with When the power receiving pole 41 abuts, the electromagnet 39 is charged to attract the lock lever 36 to move downward. After the lock lever 36 is moved out of the lock groove 45, the sealed door 46 is opened. The controller 44 controls the action of the electric push rod 55, thereby driving the sliding block 54 to move downward, thereby driving the fifth gear 48 to mesh with the fourth gear 50, and at this time, the rotating frame 11 stops rotating;

2. When the item to be inspected is light, place the item directly in the detection cavity 12. If the item to be inspected is heavy, start the driving motor 53 to drive the fifth gear 48 to rotate, thereby driving the The fourth gear 50 rotates, thereby driving the fourth rotating shaft 51 to rotate, thereby driving the second bevel gear 22 to rotate, thereby driving the first bevel gear 21 to rotate, thereby driving the worm 19 to rotate, thereby driving the The worm wheel 18 rotates, thereby driving the swing lever 16 to swing downward, thereby driving the support plate 15 to move downward. At this time, an article is placed above the support plate 15 and the driving motor 53 is started to drive the fifth gear. 48 rotates in the reverse direction, thereby driving the support plate 15 to move to the original position, at this time, the article is pushed into the detection cavity 12, and the sealed door 46 is released at this time, and the sealed door 46 is at The torsion spring 14 is reset;

3. At this time, the sensor 44 senses the sealed door 46, thereby driving and controlling the electric push rod 55 to move the sliding block 54 up, and the upward movement of the sliding block 54 drives the fifth gear 48 and The third gear 47 meshes, and at this time, the driving motor 53 drives the fifth gear 48 to rotate, thereby driving the third gear 47 to rotate, thereby driving the first rotating shaft 26 to rotate, thereby driving the first The gear 33 rotates, thereby driving the second gear 32 to rotate, thereby driving the turret 11 to rotate, thereby driving the items requiring security inspection to be washed. When both of the contact points 40 abut the electric pole 41 The controller 20 is powered on, thereby driving the X-ray generator (not shown) to illuminate the lower left corner of the detection chamber 12 once. At this time, the X-ray imager 28 forms an image for security after receiving the X-ray. Personnel checked that the inspected items moved downwards with the rotation of the turret 11 so as to move out of the exit provided in the right end wall of the detection chamber 12 above the conveyor belt 25. At this time, due to the first rotating shaft 26 rotation drives the transmission wheel 27 to rotate, thereby The conveyor belt 25 is driven to rotate, so that the security-checked articles are sent out of the main body 10.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A device using X-rays for security detection includes a fuselage and a detection cavity provided in the fuselage and connected to the left and right sides of the fuselage. A power receiving ring is provided at the middle position of the rotating frame, a sliding groove is provided in the four brackets provided on the rotating frame, and a power receiving pole is slidably arranged in the sliding groove. A first spring is provided between the sliding groove wall bodies, and an electrical wire is electrically connected between the electric pole and the electric ring, and an X-ray generator (not shown) is disposed in the front end wall of the lower left corner.), An X-ray imager that generates X-rays due to receiving an X-ray generator (not shown) is provided in the rear end wall of the lower left corner of the detection cavity, and the left end wall and the bottom wall of the detection cavity are provided with A contact that cooperates with the power pole, and a controller that controls the activation of the X-ray generator (not shown) is provided between the two contacts, and when the two contacts are connected to the power at the same time When the lever abuts, the controller controls the X-ray generator (not shown) to illuminate the lower left corner of the detection cavity. Once shot, at this time, the X-ray imager receives an X-ray to form an image for security personnel to inspect. The inspected items move downward with the rotation of the turret, and are set from the inside of the right end wall of the detection cavity. The exit is moved above the conveying device provided in the fuselage, and the conveyor belt provided in the transmission device is rotated to move the inspected equipment out of the equipment;
A rotatable seal door is provided at the left entrance of the detection cavity, and the seal door can be opened only when both of the contacts are in contact with the power pole. The turret is not rotating; a lifting device for lifting heavy objects is provided on the left side of the fuselage, and the lifting device drives the support plate provided on the left side of the fuselage to move up and down to move the weight from a lower position to the detection cavity. The entrance set on the left.

2. The device for detecting security by using X-rays according to claim 1, wherein the transmission device comprises a transmission cavity provided in the fuselage, and a left-right symmetrical first section is rotatably disposed in the transmission cavity. A rotating shaft, the outer surfaces of the left and right two first rotating shafts are fixedly provided with a transmission wheel driven by the conveyor belt, and the rear end of the first rotating shaft on the left side extends into the rear end wall of the detection cavity. A first gear is fixedly disposed at the end of the first rotating shaft in the engaging cavity, and a second rotating shaft fixedly connected to the rotating frame is rotatably provided between the rotating frame and the engaging cavity. A second gear meshing with the first gear is fixedly provided at the end of the second rotating shaft in the meshing cavity, and the front end of the first rotating shaft on the left side extends into the front end wall of the conveying cavity. A third gear is fixedly disposed in the transmission cavity and at the end.

3. The apparatus for security detection using X-rays according to claim 1, characterized in that: the sealed door is hingedly connected to the top wall of the detection cavity, and a driving force is provided between the sealed door and the hinge shaft. A torsion spring for automatic reset of a sealed door, a groove is provided in the right end wall of the fuselage, a sliding hole with an upward opening is provided in the bottom wall of the groove, and a top end extension is slidably provided in the sliding hole. Into a lock groove provided in the bottom wall of the sealed door, an electromagnet matching the lock lever is provided in the bottom wall of the sliding hole, and a second spring is provided between the lock lever and the electromagnet, An inductor that senses the sealed door is disposed in the right end wall of the groove.

4. The device for detecting security by using X-rays according to claim 1, wherein the lifting device comprises a third rotating shaft that is rotatably disposed on the left side of the fuselage, and an outer surface of the third rotating shaft is fixed with a swing. A lever, the swing lever is articulatedly connected to the bottom wall of the support plate at an end far away from the third rotation shaft, and the support plate is articulated with a front-rear symmetrical hinge rod, and the hinge rod is far from the support The end of one side of the plate is rotatably connected to the end wall of the fuselage. A rotation cavity is provided in the bottom wall of the transfer cavity, and a left end wall of the rotation cavity is rotatably provided with an outer surface of the third rotation shaft. A worm gear meshed with a worm gear, a first bevel gear is fixedly disposed at the end of the worm in the rotation cavity, and a fourth rotation shaft is rotatably disposed between the rotation cavity and the transmission cavity, and the first A second bevel gear meshing with the first bevel gear is fixedly disposed at the end of the four rotation shafts, and a fourth gear is fixedly disposed at the end of the fourth rotation shaft in the transmission cavity.

5. The device for detecting security by using X-rays according to claim 1, characterized in that: a sliding cavity with an opening forward is provided in the rear end wall of the transmission cavity, and a slide is slidably provided in the sliding cavity Block, a driving motor is fixedly arranged in the front end wall of the sliding block, a fifth gear meshing with the third gear is fixedly arranged at the end of the output shaft of the driving motor, and the top wall of the sliding cavity is provided with The sensor is electrically connected with the electric push rod.
